(19) United States
(12) Patent Application Publication
(10) Pub. No.: US 2015/0318550 A1
(43) Pub. Date: Nov. 5, 2015

(54) CARBON NANOTUBE DISPERSION AND METHOD FOR MANUFACTURING DISPERSION

(71) Applicant: Takeshi HASHIMOTO, Nagoya-shi Aichi (JP)

(72) Inventor: Takeshi HASHIMOTO, Nagoya-shi Aichi (JP)

(21) Appl. No.: 14/424,203

(22) PCT Filed: Aug. 27, 2012
(86) PCT No.: PCT/JP2012/071581

§ 371 Date: Jul. 13, 2015

(51) Int. Cl. H01M 4/62; C01B 31/02

(52) U.S. Cl. CPC H01M 4/625; C01B 31/0273; C01B 2202/06; H01M 10/0525

(57) ABSTRACT

Disclosed is a manufacturing method, which includes: loading a liquid medium into a dispersing container; loading carbon nanotubes into the dispersing container and adjusting the viscosity of the contents of the dispersing container to a prescribed loading target value; and subjecting the contents of the dispersing container to a dispersion treatment using an annular gap-type bead mill and bringing the viscosity of the contents to a prescribed dispersion target value. A characteristic feature of this manufacturing method is that carbon nanotube loading and the dispersion treatment are repeated until the carbon nanotube concentration of the contents of the dispersing container reaches a desired value. This manufacturing method can bring about a homogeneous dispersion even with a high-concentration carbon nanotube dispersion.

### TECHNICAL FIELD

The present invention relates to a carbon nanotube dispersion in which carbon nanotubes (CNTs) are dispersed in a liquid medium. The present invention also relates to a method for manufacturing this dispersion.

### BACKGROUND ART

Carbon nanotubes (CNTs) are materials that have excellent properties with regard to, e.g., electrical conductivity, thermal conductivity, and mechanical strength, and that have thus received attention in numerous fields. For example, carbon nanotubes are used in the electrodes of lithium ion secondary batteries and specifically as an electroconductive material incorporated in the electrode mixture layer, which is composed mainly of an electrode active material and is formed on the surface of the current collector that is an electrode constituent.

Carbon nanotubes are not only used by themselves, but various investigations have also been carried out into their use as composite materials in which they are dispersed in another material. For example, a carbon nanotube dispersion in which carbon nanotubes are dispersed in a liquid medium can be used as an electroconductivity-imparting agent and as an antistatic agent.

Carbon nanotubes (CNTs) are generally produced in a state in which a large number of tubes are aggregated. Patent Literature 1 describes an example of a method for dispersing these aggregated carbon nanotubes (CNTs) in another material (a liquid medium). In the art described in Patent Literature 1, a surfactant having an alkyl ester group, a vinylidene group, and an anionic substituent (for example, dodecyl itaconate) is added to the dispersion as a dispersing agent. Other art related to carbon nanotube dispersions is disclosed in Patent Literature 2 and Patent Literature 3.

### CITATION LIST

### Patent Literature

### Patent Literature 1: Japanese Patent Application Laid-open No. 2010-13312

### Patent Literature 2: Japanese Patent Application Laid-open No. 2011-207632

### Patent Literature 3: Japanese Patent Application Laid-open No. 2011-213500

### SUMMARY OF INVENTION

When a carbon nanotube dispersion is used, for example, as an electroconductivity-imparting agent, such as an electroconductive material in a lithium ion secondary battery, a high carbon nanotube concentration in this dispersion and a homogeneous dispersion are required. This makes it possible for the carbon nanotubes to be present homogeneously in the coated product from the dispersion, which then results in the formation by the dispersed carbon nanotube product of a network with an excellent electroconductivity.

However, with regard to a carbon nanotube product that is a collection of individual very fine carbon nanotubes, aggregates may form in a dispersion as shown in FIG. 2 and FIG. 3, infra, due to the ease with which aggregation among the tubes occurs. These aggregates readily form in a high-concentration carbon nanotube dispersion. Since it is difficult to form a homogeneous electroconductive network with a dispersion in which a large number of such aggregates have formed, it is thus difficult to improve the electroconductivity even using a high concentration. In addition, a dispersion that contains numerous aggregates has a high viscosity, which is unfavorable because this also impairs handling in applications other than as an electroconductivity-imparting agent.

In the art described in Patent Literature 1, a highly dispersed high-concentration carbon nanotube dispersion is produced by the use of a special surfactant as a dispersing agent. However, the range of applications may be narrow due to the use of this special surfactant. In addition, according to information provided in Patent Literature 1, the viscosity of the dispersion ends up rising when the production of a dispersion having a carbon nanotube concentration of equal to or greater than 20 mass % is pursued using this method.

Thus, an object of the present invention is to provide a method for manufacturing a highly dispersed high-concentration carbon nanotube dispersion. An additional object of the present invention is to provide the highly dispersed high-concentration carbon nanotube dispersion yielded by this manufacturing method.

In order to achieve these objects, the present invention provides a method for manufacturing a carbon nanotube dispersion that has carbon nanotubes (CNTs) dispersed in a liquid medium. The herein disclosed manufacturing method includes loading the liquid medium into a dispersing container; loading carbon nanotubes (CNTs) into the dispersing container and adjusting the viscosity of the contents of the dispersing container to between 100 cP and 100,000 cP; and subjecting the contents of the dispersing container to a dispersion treatment using an annular gap-type bead mill until the viscosity of the contents reaches a dispersion target value (inclusive of a target range) set between 10 cP and 50,000 cP.

In addition, the herein disclosed manufacturing method is characterized in that the carbon nanotube (CNTs) loading and the dispersion treatment are repeated until the carbon nanotube concentration of the contents of the dispersing container reaches a desired value.

The carbon nanotubes (CNTs) present in the contents undergo scission in the herein disclosed manufacturing method due to the execution of the dispersion treatment using an annular gap-type bead mill. This results in the dispersion of carbon nanotubes (CNTs) that are shorter than before loading into the liquid medium. Shorter carbon nanotubes (CNTs) have a higher dispersibility and are more resistant to aggregate formation than are longer carbon nanotubes (CNTs). Due to this a dispersion can be prepared in which even at high concentrations the carbon nanotubes (CNTs) are homogeneously dispersed.

In addition, after the viscosity of the contents of the dispersing container has been adjusted to provide a prescribed loading target value, in the herein disclosed manufacturing method a dispersion treatment is carried out until a prescribed dispersion target value is reached. The loading of the carbon nanotubes (CNTs) and the dispersion treatment are repeated until a dispersion having a desired concentration is obtained (this is preferably a dispersion in which the carbon nanotube concentration (content) for the overall contents of the dispersing container is 1 mass % to 50 mass %). Doing this prevents the formation of large numbers of aggregates prior to the dispersion treatment that can result from the loading of a large amount of carbon nanotubes (CNTs) at one time and thus prevents impediments to the dispersion treatment.

The viscosity adjustment value (also referred to herebelow as the loading target value) when the carbon nanotubes are loaded into the container is typically set to from 100 cP to 100,000 cP in the herein disclosed manufacturing method. Setting the loading target value into the indicated numerical value range makes possible a favorable execution of the dispersion treatment and also makes it possible to increase the productivity for the carbon nanotube dispersion.

The dispersion target value is typically set to between 10 cP and 50,000 cP in the herein disclosed manufacturing method. Setting the dispersion target value into this numerical value range serves to prevent the carbon nanotubes from being unnecessarily short after the dispersion treatment. It also makes possible the generation of a homogeneous dispersion of the carbon nanotubes (CNTs) in the liquid medium as a whole and in addition can increase the productivity.

As has been described in the preceding, the herein disclosed manufacturing method can bring about a homogeneous dispersion of carbon nanotubes (CNTs) in the liquid even for a dispersion that contains a high concentration of the carbon nanotubes (CNTs). The resulting highly dispersed high-concentration carbon nanotube dispersion can be favorably used as a carbon nanotube material in a variety of fields.

Multi-walled carbon nanotubes (MWNTs) are used as the carbon nanotubes in a preferred aspect of the herein disclosed manufacturing method.

Because they have a lower interatomic crystallinity than single-walled carbon nanotubes (SWNTs), multi-walled carbon nanotubes (MWNTs) more readily undergo scission perpendicular to the length direction. As a consequence, the basic tubular structure is not destroyed by the dispersion treatment in accordance with the manufacturing method with this structure and in addition a dispersion of shorter carbon nanotubes can be brought about.

In another preferred aspect of the herein disclosed manufacturing method, a polymer compound that functions as a dispersing agent is dissolved in the liquid medium prior to the loading of the carbon nanotubes into the dispersing container (or at the same time as the loading of the carbon nanotubes).

A dispersion in which the carbon nanotubes (CNTs) are even more favorably dispersed can be obtained in accordance with the manufacturing method with this structure. The dispersing agent here can be varied as appropriate in conformity with the type of liquid medium. Specifically, when an aqueous liquid medium is used, for example, carboxymethyl cellulose (CMC), polyvinylpyrrolidone (PVP), acrylic resin emulsions, water-soluble acrylic polymers, styrene emulsions, silicone emulsions, acrylic-silicone emulsions, fluororesin emulsions, EVA emulsions, vinyl acetate emulsions, vinyl chloride emulsions, and urethane resin emulsions are advantageously used. When an organic liquid medium is used, for example, polyvinyl acetal, polyvinylpyrrolidone polyvinylidene fluoride (PVDF), acrylic resins, alkyd resins, and urethane resins are advantageously used.

In a preferred aspect of the herein disclosed manufacturing method, the average value of the aspect ratio of the carbon nanotubes after the dispersion treatment is maintained at at least 50% of the average value of the aspect ratio of the carbon nanotubes prior to loading into the dispersing container. For example, carbon nanotubes with an average value for the aspect ratio of at least 100 (typically not more than 1000 and preferably not more than 500, for example, not more than 300) are loaded in the dispersing container. An excellent carbon nanotube dispersion can be produced using the herein disclosed manufacturing method even when the starting material is a carbon nanotube (CNTs) having such a high aspect ratio.

As previously indicated, the shorter carbon nanotubes obtained by scission of the carbon nanotubes (CNTs) due to the dispersion treatment have the property of being more resistant to aggregate formation and thus of being more easily homogeneously dispersed in the liquid medium. However, when the carbon nanotube aspect ratio becomes too small, the risk arises that the properties of the carbon nanotubes that are provided by the presence of their tubular structure will be weakened. A dispersion of homogeneously dispersed carbon nanotubes (CNTs) that retain a prescribed aspect ratio can be manufactured using the manufacturing method according to the aforementioned aspect. Such a carbon nanotube dispersion can exhibit excellent effects in a variety of applications. For example, when such a dispersion is used as an electroconductive material for lithium ion secondary batteries, a highly electroconductive network of carbon nanotubes (CNTs) can be fabricated throughout the entire electrode mixture layer using a small amount of the dispersion. This then makes it possible to raise the density of the electrode active material constituent of the electrode mixture layer and can thereby contribute to improving the battery properties.

In another aspect the present invention provides a carbon nanotube dispersion in which carbon nanotubes are dispersed in a liquid medium. There herein disclosed carbon nanotube dispersion has a carbon nanotube concentration with reference to the carbon nanotube dispersion as a whole of from at least 1 mass % to not more than 50 mass % and has a viscosity for the carbon nanotube dispersion of 10 cP to 50,000 cP. In addition, the average value of the aspect ratio of the carbon nanotubes in this dispersion is preferably 50 to 200.

In a preferred aspect of the herein disclosed carbon nanotube dispersion, it has a low viscosity (highly disperse character) of 10 cP to 50,000 cP even though it is a high-concentration dispersion, for example, of from at least 1 mass % to not more than 30 mass %. This highly dispersed high-concentration carbon nanotube dispersion can be favorably used as an electroconductive material for the fabrication of an advantageous electroconductive network. Moreover, it is easy to mold or form due to its low viscosity notwithstanding its high concentration, and it can thus also be favorably used, for example, as a filler in the production of ceramic composite materials. Moreover, since the average value of the aspect ratio of the carbon nanotubes is 50 to 200 (for example, 150 to 200), the properties arising due to the tubular structure of the carbon nanotubes are not weakened and use as a favorable carbon nanotube composite material is thus made possible.

In another preferred embodiment of the herein disclosed carbon nanotube dispersion, the carbon nanotubes are multi-walled carbon nanotubes.

### BRIEF DESCRIPTION OF DRAWINGS

FIG. 1 is a diagram that schematically shows an example of a device for carrying out the herein disclosed manufacturing method (a device for manufacturing a carbon nanotube dispersion);

FIG. 2 is an SEM photograph (10,000× enlargement) prior to the dispersion treatment of sample 1;

FIG. 3 is an SEM photograph (10,000× enlargement) prior to the dispersion treatment of sample 2;

FIG. 4 is an SEM photograph (10,000× enlargement) after the dispersion treatment of sample 1;

FIG. 5 is an SEM photograph (10,000× enlargement) after the dispersion treatment of sample 2;

FIG. 6 is an SEM photograph (50,000× enlargement) after the dispersion treatment of sample 1; and

FIG. 7 is an SEM photograph (50,000 enlargement) after the dispersion treatment of sample 2.

### DESCRIPTION OF EMBODIMENTS

Preferred embodiments of the present invention are described herebelow. Matters required for the execution of the present invention but not particularly described in this Description (for example, methods for producing the carbon nanotubes) can be understood as design matters for the individual skilled in the art based on the conventional art in the pertinent field. The present invention can be implemented based on the contents disclosed in this Description and the common general technical knowledge in the pertinent field.

<The Method for Manufacturing a Carbon Nanotube Dispersion>

The herein disclosed method for manufacturing a carbon nanotube dispersion (referred to herebelow as the “manufacturing method” as appropriate) is described here. In this Description, the “carbon nanotube dispersion (referred to herebelow as the “dispersion” as appropriate)” denotes a composition in which carbon nanotubes (CNTs) are dispersed in a liquid medium and encompasses ink-form compositions and paste-form in which the carbon nanotubes (CNTs) are present at high concentrations.

1. Preparation of the Starting Materials

The starting materials used in the herein disclosed manufacturing method are described first. The herein disclosed manufacturing method uses carbon nanotubes and a liquid medium as starting materials. In addition to the carbon nanotubes and liquid medium, a polymer compound that can function as a dispersing agent may also be used as a secondary starting material.

1-1. The Carbon Nanotubes

The type of carbon nanotube used as a starting material for the dispersion (i.e., the carbon nanotube to be dispersed) is not a particular limitation on the present invention. For example, carbon nanotubes (CNTs) produced by various methods, e.g., arc discharge methods, laser vaporization methods, and chemical vapor deposition methods (CVD methods), can be selected as appropriate and used.

In addition, single-walled carbon nanotubes (SWNTs), multi-walled carbon nanotubes (MWNTs), and mixtures containing these in any proportions may be used without limitation as the carbon nanotubes (CNTs). Among the preceding, the use of multi-walled carbon nanotubes in the herein disclosed manufacturing method is particularly preferred. Because they have a lower interatomic crystallinity than single-walled carbon nanotubes, multi-walled carbon nanotubes more readily undergo scission in the direction perpendicular to the length direction during the dispersion treatment, infra. As a consequence, a carbon nanotube dispersion can be obtained in which a homogeneous dispersion is achieved while satisfactorily maintaining the tubular structure of the carbon nanotubes intact.

A carbon nanotube aggregate (including carbon nanotube bundles) in which a large number of carbon nanotubes are aggregated may also be used for the carbon nanotubes (CNTs) used as a starting material. The herein disclosed manufacturing method can produce a highly dispersed dispersion even when a starting material such as already aggregated carbon nanotubes (CNTs) is used.

The average value for the diameter of these carbon nanotubes (typically the value measured based on electron microscopic observation) may be 1 nm to 300 nm (preferably 5 nm to 200 nm, for example, 10 nm to 150 nm). A suitable preferred diameter can be selected for the carbon nanotube diameter in conformity to the application of the dispersion after its manufacture. The herein disclosed manufacturing method can prevent the formation of aggregates and can produce a homogeneously dispersed dispersion even with very fine carbon nanotubes of about 5 nm.

The average value of the length of the carbon nanotubes used as a starting material (typically the value measured based on electron microscopic observation) may also be varied as appropriate depending on the application of the produced dispersion. In specific terms, the average length is at least equal to or greater than about 1 μm and is preferably equal to or greater than about 3 μm (typically 3 μm to 100 μm, preferably 3 μm to 50 μm, for example, 3 μm to 30 μm).

The average value of the aspect ratio (carbon nanotube length/diameter) of the carbon nanotubes used as a starting material may be 10 to 1,000 (typically 100 to 1,000, preferably 100 to 500, and more preferably 100 to 300). A larger average value for this aspect ratio has the advantage from a structural standpoint of facilitating the formation of an electroconductive network in the dispersion, but conversely also produces the disadvantage of facilitating aggregate formation. The herein disclosed manufacturing method can extinguish this disadvantage because it enables the generation of a homogeneous dispersion even for carbon nanotubes with a high aspect ratio.

Using the overall dispersion as 100 mass %, the carbon nanotube loading amount (content) can be 1 mass % to 50 mass % (preferably 1 mass % to 30 mass %, for example, 10 mass % to 30 mass %) in the herein disclosed manufacturing method. The carbon nanotube loading amount can be varied as appropriate in conformity to the purpose (application) for the dispersion that is produced.

Impurities produced, for example, during fabrication (for example, catalytic metal, a carbon component such as amorphous carbon, and so forth) may be present in the carbon nanotubes. The carbon nanotube used may be a carbon nanotube that has been subjected to a freely selected post-treatment in order to remove these impurities (for example, a purification treatment such as removal of the amorphous carbon, removal of the catalytic metal, and so forth).

1-2. The Liquid Medium

The liquid medium that disperses the carbon nanotubes can be varied as appropriate in conformity to the purpose of the dispersion that is produced. For example, when the produced dispersion is to be used as an electroconductive material in a lithium ion secondary battery, an aqueous solvent (typically pure water) or a nonaqueous solvent (for example, toluene, N-methyl-2-pyrrolidone (NMP), methyl ethyl ketone, and so forth) is preferably used. These solvents are solvents that are also used as the dispersing media for dispersing, for example, the electrode active material, when the electrode mixture layer of a secondary battery, such as the abovementioned lithium ion secondary battery, is formed, and the use of the same solvent for the liquid medium enables the manufacture of a carbon nanotube dispersion that can be more easily utilized as an electroconductive material for lithium ion secondary batteries.

Alcohol-based solvents are another example of the liquid medium. A single selection or two or more selections from ordinary alcohols that are liquids in the temperature region around room temperature (for example, 23° C. to 25° C.) can be used as this alcohol-based solvent. The type and composition of the alcohol-based solvent can be selected as appropriate in conformity to, for example, the purpose and mode. Alcohol-based solvents preferred for the execution of the present invention can be exemplified by lower alcohols and typically by lower alcohols that have approximately 1 to 4 carbons. Lower alcohols that can dissolve the polyvinyl acetal resins described below are more preferred. Such lower alcohols can be exemplified by lower alcohols that have 1 to 4 carbons, e.g., methanol, ethanol, 1-propanol, 2-propanol (isopropyl alcohol), 1-butanol (n-butanol), 2-methyl-1-propanol (isobutanol), 2-butanol (sec-butanol), and 1-methyl-2-propanol (tert-butanol). Only one of these lower alcohols (for example, ethanol or 2-methyl-1-propanol) or a mixed alcohol in which at least two of these lower alcohols (for example, ethanol and 1-butanol) are mixed in a suitable mixing ratio is preferably used as the alcohol-based solvent.

A dispersion in which such a lower alcohol has been selected as the liquid medium is favorable for the preparation of carbon nanotubes. Specifically, since these lower alcohols have a high volatility, carbon nanotubes can be readily obtained by coating the dispersion on a plate-shaped member and removing (drying) the alcohol from the coated material.

1-3. The Dispersing Agent

A polymer compound that can function as a dispersing agent is preferably used as another starting material in the herein disclosed manufacturing method. This dispersing agent can improve the dispersibility of the carbon nanotubes through its addition to the liquid medium prior to or at the same time as carbon nanotube loading. The polymer compound capable of functioning as this dispersing agent may be selected in conformity to the type of liquid medium. Specifically, when an aqueous solvent is used, for example, carboxymethyl cellulose, polyvinylpyrrolidone (PVP), an acrylic resin emulsion, a water-soluble acrylic polymer, a styrene emulsion, a silicone emulsion, an acrylic-silicone emulsion, a fluororesin emulsion, an EVA emulsion, a vinyl acetate emulsion, a vinyl chloride emulsion, or a urethane resin emulsion is preferably used as the dispersing agent. When, on the other hand, an organic solvent is used as the liquid medium, the dispersing agent is again preferably selected in conformity to the type of this solvent. When, for example, N-methyl-2-pyrrolidone is used as the liquid medium, polyvinyl butyral (for example, S-LEC (trademark) BL-10 and BX-L from Sekisui Chemical Co., Ltd.), polyvinylpyrrolidone (PVP), polyvinylidene fluoride (PVDF), acrylic resin, alkyd resin, urethane resin, and so forth are preferably used.

Using 100 mass % for the carbon nanotubes, the amount of addition of this dispersing agent may be about 1 to 100 mass %. This makes it possible to bring about a more favorable dispersion of the carbon nanotubes in the liquid medium.

1-4. Other Additions

In addition to the starting materials that have been described above, various additives may be used as secondary components on an optional basis in the herein disclosed manufacturing method. These additives can be exemplified by surfactants, oxidation inhibitors, viscosity modifiers, pH modifiers, preservatives, and so forth.

2. Loading of the liquid medium

The individual steps of the herein disclosed manufacturing method are described in the following. The above-described liquid medium is first loaded into the dispersing container in the herein disclosed manufacturing method. The dispersing container should be a container that can hold and that enables the dispersion of the liquid medium and carbon nanotubes, but is not otherwise a particular limitation on the present invention. Prior to the loading of the liquid medium, the individual starting materials as described above may be measured out so as to obtain a dispersion with the desired concentration.

When a polymer compound that can function as a dispersing agent is used, the dispersing agent may be added to the liquid medium after the liquid medium has been loaded and prior to or at the same time as the loading of the carbon nanotubes, infra. In this case, the liquid medium containing the dispersing agent is thoroughly stirred in order to dissolve the dispersing agent in the liquid medium. By doing this, aggregation among the carbon nanotubes can be prevented.

3. Loading (Addition) of the Carbon Nanotubes

The carbon nanotubes are then loaded into the dispersing container. When a carbon nanotube powder product is used as the starting material, the carbon nanotubes (CNTs) may be gently loaded followed by standing for a brief period of time and then slow stirring (for example, about 1,200 rpm) of the contents of the dispersing container. Doing this prevents the carbon nanotubes that float on the liquid medium when loading is performed from being propelled up into the air. Loading of the carbon nanotubes into the dispersing container and stirring produces a low-dispersity carbon nanotube dispersion and an increase in the viscosity of the contents of the dispersing container.

In the herein disclosed manufacturing method, the carbon nanotubes are loaded into the dispersing container so that the viscosity of its contents (the low-dispersity carbon nanotube dispersion) reaches a pre-set loading target value (target range). This “loading target value” is a value pre-set with the purpose of preventing the carbon nanotubes from unnecessarily aggregating with each other during stock liquid preparation and thus impeding the favorable execution of the dispersion treatment, infra. This loading target value is preferably set within the range from 100 cP to 100,000 cP. An example of this loading target value is approximately 10,000 cP to 60,000 cP. When an extremely high loading target value is set, the viscosity of the dispersing contents become unnecessarily high and the risk arises that a favorable execution of the dispersion treatment, infra, may then not be possible. When, on the other hand, an extremely low loading target value is set, the carbon nanotube re-loading and dispersion treatment must then be repeated many times and the productivity ends up declining. Setting the loading target value within the numerical value range indicated above makes it possible to favorably execute the dispersion treatment and at the same time to boost the productivity of the herein disclosed manufacturing method.

The viscosity can be conveniently measured using the usual viscometers that are used to measure the viscosity of this type of dispersion, for example, a commercial B-type viscometer or a rotating cylinder viscometer.

Loading of the carbon nanotubes and stirring are typically continued in the herein disclosed manufacturing method until the viscosity of the contents of the dispersing container reaches the loading target value (target range). Once the viscosity has reached the loading target value (target range), loading of the carbon nanotubes is stopped and the dispersion treatment is begun. The occurrence of error in the viscosity of the contents relative to the loading target range is certainly allowable in the actual loading of the carbon nanotubes. For example, approximately the loading target value ±500 cP is preferred for this error range.

4. The Dispersion Treatment

The contents of the dispersing container are then subjected to a dispersion treatment using an annular gap-type bead mill in the herein disclosed manufacturing method. An annular gap-type bead mill is a device in which a dispersing compartment is formed in the gap between a cylindrical rotor and a cylindrical stator concentric therewith. With such a bead mill, the beads and sample are filled into the dispersing compartment and the target is then dispersed within the dispersing compartment through the rotation of the rotor. A higher energy density for dispersion is generated in such an annular gap-type bead mill by setting a narrower gap between the rotor and the stator. The dispersion velocity for this annular gap-type bead mill may be a peripheral velocity of 5 nm/s to 25 m/s (preferably 8 m/s to 20 m/s, for example, 15 m/s).

Scission of the carbon nanotubes in the contents can be brought about by subjecting the contents of the dispersing container to a dispersion treatment with such a bead mill. The shorter carbon nanotubes thereby obtained can be homogeneously dispersed even when the carbon nanotubes are present at a high concentration with respect to the dispersion as a whole. For example, the execution of the dispersion treatment on carbon nanotubes (CNTs) having an average length in excess of 5 μm can adjust at least 80% (and preferably at least 90%) of the total carbon nanotubes to equal to or less than 5 μm and can thereby improve the dispersibility.

The viscosity of the contents of the dispersing container is brought to equal to or less than a pre-set dispersion target value in this dispersion treatment. This “dispersion target value” is a value pre-set with the purpose of preventing unnecessary scission of the carbon nanotubes while achieving a homogeneous dispersion of the contents of the dispersing container. When an extremely high dispersion target value is set, carbon nanotube re-loading and the dispersion treatment must then be repeated many times and the productivity ends up declining. When an extremely low dispersion target value is set, carbon nanotube scission progresses to the point that very short carbon nanotubes are formed, and because of this the risk arises that the carbon nanotube properties may be impaired. The dispersion target value after all of the measured-out carbon nanotubes have been loaded should be set to a viscosity such that a desired dispersity is obtained. The dispersion target value is preferably, for example, set into the range from 10 cP to 50,000 cP (for example, 10 cP to 10,000 cP). An example of this dispersion target value is approximately 1,000 cP to 8,000 cP. In this case, the dispersed carbon nanotubes can be prevented from becoming unnecessarily short at the same time that a highly dispersed carbon nanotube dispersion, i.e., with a viscosity of not more than 8,000 cP, is obtained. The average value of the aspect ratio of the carbon nanotubes obtained when this is done will be, for example, 25% to 75% of that prior to scission.

In the herein disclosed manufacturing method, the viscosity of the contents declines as the contents of the dispersing container (the low-dispersity carbon nanotube dispersion) become more homogeneously dispersed due to the dispersion treatment. Measurement of the viscosity of the contents of the dispersing container is continued, and, when the dispersion target value has been reached, the dispersion treatment is halted on an interim basis and the next step is begun. The occurrence of error in the viscosity of the contents relative to the dispersion target range is certainly also allowable in the dispersion treatment. This error range is approximately the dispersion target value ±500 cP.

5. Re-Loading and Re-Dispersion of the Carbon Nanotubes

A characteristic feature of the herein disclosed manufacturing method is that the loading of the carbon nanotubes and the dispersion treatment are repeated until the carbon nanotube concentration of the contents of the dispersing container reaches a desired value. More specifically, in the herein disclosed manufacturing method the dispersion treatment is stopped on an interim basis when the viscosity of the contents of the dispersing container has been brought to the dispersion target value by the dispersion treatment. Carbon nanotubes are again loaded into the dispersing container until the viscosity of the contents reaches the loading target value, and the dispersion treatment is run again until the dispersion target value is reached. By repeating this “loading of the carbon nanotubes” and “dispersion treatment”, the herein disclosed manufacturing method makes it possible to bring the carbon nanotube concentration closer and closer to the desired value while maintaining a low viscosity for the contents (the carbon nanotube dispersion) of the dispersing container. A highly dispersed high-concentration carbon nanotube dispersion can be obtained as a consequence.

6. The Product

The carbon nanotube dispersion produced by the herein disclosed manufacturing method is described in the following. This manufacturing method can, through appropriate adjustment of the target concentration and the dispersion target value, produce a carbon nanotube dispersion adapted to a particular application.

For example, the herein disclosed manufacturing method can produce a carbon nanotube dispersion that has a carbon nanotube concentration of from at least 1 mass % to not more than 50 mass % (preferably from at least 1 mass % to not more than 30 mass %) and that has a viscosity of 10 cP to 50,000 cP (preferably 10 cP to 10,000 cP). Such a carbon nanotube dispersion can be favorably used, for example, as an electroconductive material for addition to the electrode mixture layer of a lithium ion secondary battery. Specifically, such a dispersion can form an excellent electroconductive network throughout the mixture layer by the addition of just a small amount to the electrode mixture layer. As a consequence of this, the density of the material that mediates charge/discharge (the electrode active material) in the electrode mixture layer can be increased by the amount by which the addition of the electroconductive material is reduced. That is, the herein disclosed carbon nanotube dispersion enables the fabrication of a lithium ion secondary battery with battery properties that are superior to those for the use of a particulate carbon material (for example, acetylene black) as the electroconductive material.

In addition, the average value of the aspect ratio of the carbon nanotubes in the dispersion may be maintained at 1% to 80%, preferably 10% to 75%, particularly preferably 25% to 75%, and, for example, 50% to 60% of the average value of the aspect ratio of the carbon nanotubes that are used as the starting material. When the carbon nanotubes are too short (the aspect ratio is too small), their shape approaches a particulate shape and the formation of an excellent electroconductive network is then impaired. Because the aspect ratio is maintained at a prescribed value in the herein disclosed manufacturing method, a favorable electroconductive network can then be constructed even at small amounts. With regard to the average value of the aspect ratio of the carbon nanotubes used as an electroconductive material in a lithium ion secondary battery, when, for example, a starting material with an average aspect ratio value of 300 is used, the average value of the aspect ratio of the carbon nanotubes in the dispersion is preferably 150 to 200 (preferably 160 to 200). In such a case an excellent electroconductive network can be formed throughout the electrode mixture layer in the lithium ion secondary battery.

The herein disclosed carbon nanotube dispersion has a variety of applications in addition to application as an electroconductive material in a lithium ion secondary battery as has been described in the preceding. For example, in the case of use as a filler in the production of ceramic composite materials, the concentration of the dispersion may be brought to 20 mass % to 30 mass % and the viscosity may be brought to 10 cP to 50,000 cP. Due to its low viscosity, a carbon nanotube dispersion having such a concentration and viscosity is easily molded or formed and through its addition as a filler enables the preparation of a ceramic composite material molding molded into a favorable shape. Moreover, due to the high concentration, a ceramic composite material molding with a higher density can be obtained. As a result of this, a ceramic composite material molding may be obtained that presents excellent mechanical properties, thermal properties, and electrical properties. In addition, the average value of the aspect ratio of the carbon nanotubes at this time is more preferably maintained at at least 50% of that prior to loading.

In the case of use as a material for forming a carbon fiber composite material, the concentration of the dispersion may be 0.01 mass % to 20 mass %. In addition the viscosity may be 10 cP to 10,000 cP. The carbon nanotube dispersion having such a concentration and viscosity is easily molded and also makes it possible to obtain high-density moldings. The average value of the aspect ratio of the carbon nanotubes at this time is more preferably maintained at at least 80% of that prior to loading.

In the case of use as a material for boron carbide, the concentration of the dispersion may be 1 mass % to 50 mass %. In addition the viscosity may be 10 cP to 50,000 cP. A highly dispersed high-concentration boron carbide dispersion can be obtained by producing boron carbide using a carbon nanotube dispersion having such a concentration and viscosity. Such a highly dispersed high-concentration boron carbide dispersion can be advantageously used for, for example, high-strength ceramic plates or boards. The average value of the aspect ratio of the carbon nanotubes at this time is more preferably maintained at at least 50% of that prior to loading.

In the case of use as the cathode in a cold cathode tube, the concentration of the dispersion may be 0.01 mass % to 10 mass %. In addition the viscosity may be 10 cP to 10,000 cP. The use of such a dispersion makes possible the production of a high carbon density cathode for a cold cathode tube. Due to the high carbon density, such a cathode offers the advantages of a fast response and a low power consumption. The average value of the aspect ratio of the carbon nanotubes at this time is more preferably maintained at at least 50% of that prior to loading.

As has been indicated in the preceding, the herein disclosed manufacturing method can produce a carbon nanotube dispersion that has a carbon nanotube concentration of from at least 1 mass % to not more than 50 mass % and that has a viscosity of 10 cP to 50,000 cP. As described in the preceding, due to its high dispersity notwithstanding its high carbon nanotube concentration, this carbon nanotube dispersion can be used as an advantageous carbon nanotube composite material in a variety of fields.

### EXAMPLES

An embodiment of the present invention has been described in the preceding. Specific examples of the herein disclosed manufacturing method will now be described. The description in these examples should not be taken as a limitation of the present invention to that which is introduced in the following.

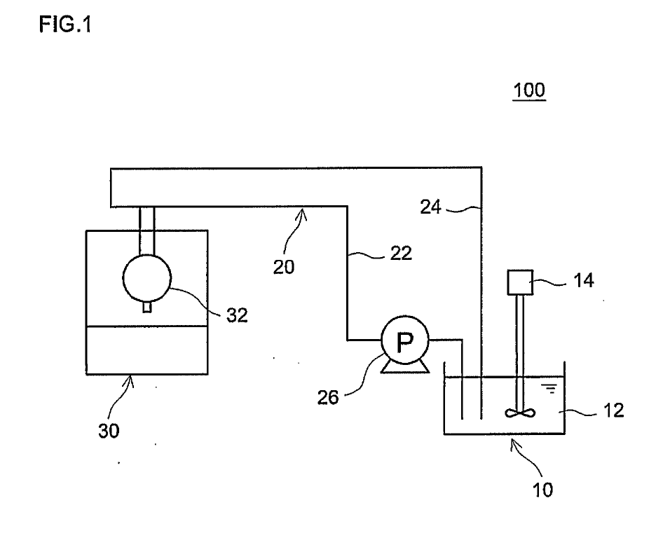

An apparatus (apparatus for manufacturing a carbon nanotube dispersion) 100 as shown in FIG. 1 is used in the here-described examples. As shown in FIG. 1, this manufacturing apparatus 100 is provided with a storage section 10, a connecting section 20, and a dispersing section 30.

A. The Storage Section

As shown in FIG. 1, the storage section 10 is a section that stores the contents (the liquid medium and carbon nanotubes) of the dispersing container and is provided with a storage tank 12 and a stirrer 14. A viscometer (not shown in the figure) is installed at the storage tank 12. The stirrer 14 is installed at the storage tank 12 and the contents in the storage tank 12 are stirred by the operation of this stirrer 14.

B. The Connecting Section

The connecting section 20 is a section that connects the storage section 10 with the dispersing section 30, infra, and it is provided with a feed line 22 and a discharge line 24. A pump 26 is disposed in the feed line 22. The contents (low-dispersity carbon nanotube dispersion) in the storage tank 12 are fed to the dispersing section 30 by the operation of the pump 26. The discharge line 24 is disposed to return the carbon nanotube dispersion that has passed through the dispersing section 30 to the storage tank 12. That is, the carbon nanotube dispersion can be circulated through the connecting section 20 between the storage section 10 and the dispersing section 30 in the manufacturing device 100 with the structure shown in FIG. 1.

C. The Dispersing Section

The dispersing section 30 is constructed of an annular gap-type bead mill as previously described. More specifically, the dispersing section 30 is provided with a cylindrical rotor and a cylindrical stator that is concentric therewith, and a dispersing compartment 32 is formed in the resulting gap. Beads are loaded into the dispersing compartment 32, and the carbon nanotube dispersion present within the dispersing compartment 32 is more thoroughly dispersed by the loaded beads when the rotor is rotated.

The procedure for the manufacturing method using this manufacturing device 100 is as follows.

I. Preparation of the Stock Liquid

A stock liquid (low-dispersity carbon nanotube dispersion) that is stored in the storage tank 12 is first prepared here. Specifically, the liquid medium is loaded into the storage tank 12 and the stirrer 14 is operated. In the case of use of any additive (for example, a dispersing agent), the additive is added in small portions to the liquid medium at this point with the stirring rate set to about 1,200 rpm. The carbon nanotubes necessary to provide a dispersion having the desired concentration are measured out in advance, and the measured-out carbon nanotubes are loaded in small portions into the liquid medium. As previously indicated, the viscosity of the contents (low-dispersity carbon nanotube dispersion) in the storage tank 12 increases as the carbon nanotubes are loaded. Once this viscosity has reached a pre-set loading target value (for example, 60,000 cP), loading is stopped even if measured-out carbon nanotubes remain. Examples of the quantities of the individual starting materials are shown in Table 1 below for the preparation of 1 L of carbon nanotube dispersion.

TABLE 1

| CNT | dispersing medium | | dispersing agent | | CNT weight |
|---|---|---|---|---|---|
| concentration | type | weight (g) | type | weight (g) | (g) |
| 1% | pure water | 988 | CMC | 2 | 10 |
| 5% | | 940 | | 10 | 50 |
| 10% | | 880 | | 20 | 100 |
| 20% | | 760 | | 40 | 200 |
| 30% | | 640 | | 60 | 300 |
| 40% | | 520 | | 80 | 400 |
| 50% | | 400 | | 100 | 500 |
| 1% | NMP | 988 | PVB | 2 | 10 |
| 5% | | 940 | | 10 | 50 |
| 10% | | 880 | | 20 | 100 |
| 20% | | 760 | | 40 | 200 |
| 30% | | 640 | | 60 | 300 |
| 40% | | 520 | | 80 | 400 |
| 50% | | 400 | | 100 | 500 |

NMP: N-methyl-2-pyrrolidone
CMC: carboxymethyl cellulose
PVB: polyvinyl butyral

II. The Dispersion Treatment

The pump 26 in the connecting section 20 is then operated and the contents in the storage tank 12 are circulated in the manufacturing device 100 in the sequence feed line 22, dispersing section 30, and discharge line 24. Once a stable discharge of the contents from the discharge line 24 has been achieved (once a stable circulation of the contents has been achieved), the dispersing section 30 (annular gap-type bead mill) is operated. As a result the contents fed into the dispersing section 30 are dispersed in the dispersing compartment 32. In addition, the contents (highly dispersed carbon nanotube dispersion) that have been dispersed at the dispersing section 30 are discharged through the discharge line 24 into the storage tank 12. Thus, in this dispersion treatment a high viscosity dispersion is fed from the storage tank 12 to the dispersing section 30 and a dispersion that has undergone dispersion in the dispersing section 30 is returned to the storage tank 12. The viscosity of the contents of the storage tank 12 is lowered with elapsed time as a consequence.

The dispersion treatment is continued, and the circulation of the contents is stopped once the viscosity of the contents in the storage tank 12 reaches the dispersion target value (for example, 8,000 cP). In addition, the contents of the storage tank 12 are stirred while the not previously loaded carbon nanotubes are loaded in small portions into the storage tank 12. When the viscosity of the contents has reached the loading target value, loading is stopped on an interim basis and the dispersion treatment is carried out until the aforementioned dispersion target value is reached. This treatment is repeated until all of the carbon nanotubes that were measured out in advance have been loaded.

III. Recovery

After all of the carbon nanotubes that were measured out have been loaded, the feed line 22 is removed from the storage tank 12 once the dispersion treatment has brought the viscosity of the contents of the storage tank 12 to the dispersion target value. The pump 26 is also operated until the return of the contents from the discharge line 24 to the storage tank 12 has ceased. By doing this, a carbon nanotube dispersion having the desired concentration (for example, 10 mass % to 50 mass %) and a high dispersity (viscosity not greater than 8,000 cP) is recovered in the storage tank 12.

(Electron Microscopic Observations Before and after the Dispersion Treatment)

A manufacturing method using the apparatus 100, which is one example of the present invention, has been described in the preceding. The state of the carbon nanotubes before and after the dispersion treatment using this manufacturing device 100 was then observed using an electron microscope (SEM: scanning electron microscope). Specifically, samples 1 and 2, in which carbon nanotubes having different shapes were dispersed, were prepared and electron photomicrographs were taken of each sample before and after the dispersion treatment.

(Sample 1)

Carbon nanotubes with diameter=30 nm, average length=3 μm, and average aspect ratio value=100 were used as the starting material for sample 1. CMC was added as a dispersing agent to the liquid medium (here, pure water) in an amount that corresponded to 1 mass % of the liquid medium (pure water). The target concentration for sample 1 was 5 mass %, and the loading target value was set to 60,000 cP and the dispersion target value was set to 8,000 cP.

(Sample 2)

Carbon nanotubes with diameter=10 nm, average length=3 μm, and average aspect ratio value=300 were used as the starting material for sample 2. Sample 2 and the aforementioned sample 1 were prepared under the same conditions, with the exception that the average aspect ratio values were different.

(The Electron Microscopic Observations)

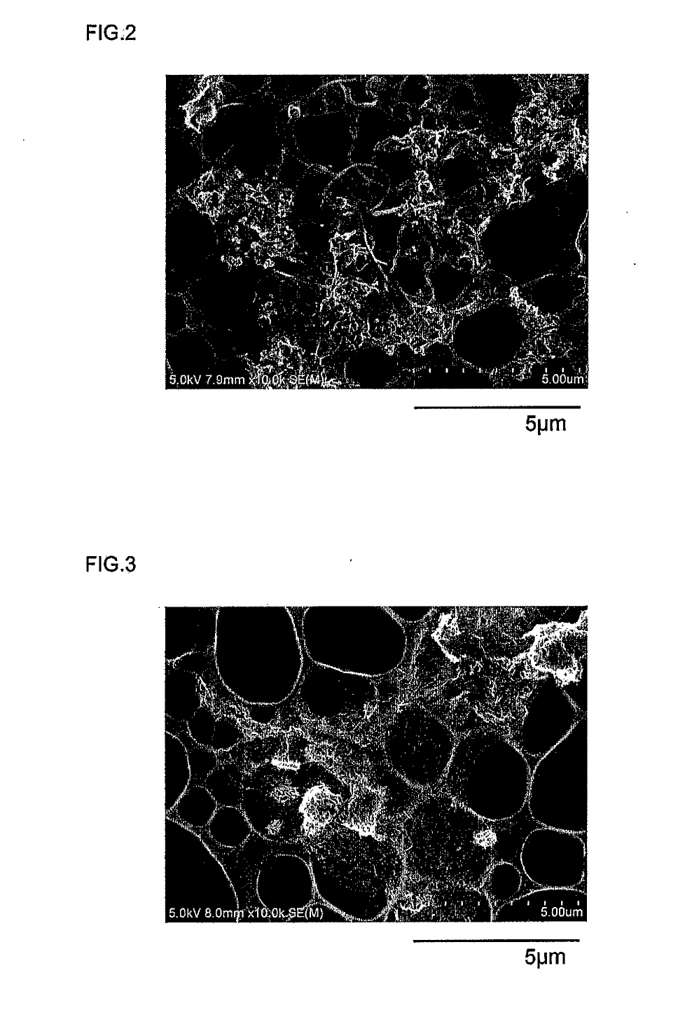

Here, the electron microscopic observation was first performed on the state of the carbon nanotubes in the contents (the low-dispersity carbon nanotube dispersion) in the storage tank 12 prior to the start of the dispersion treatment. The SEM photograph prior to the dispersion of sample 1 is given in FIG. 2, and the SEM photograph prior to the dispersion of sample 2 is given in FIG. 3.

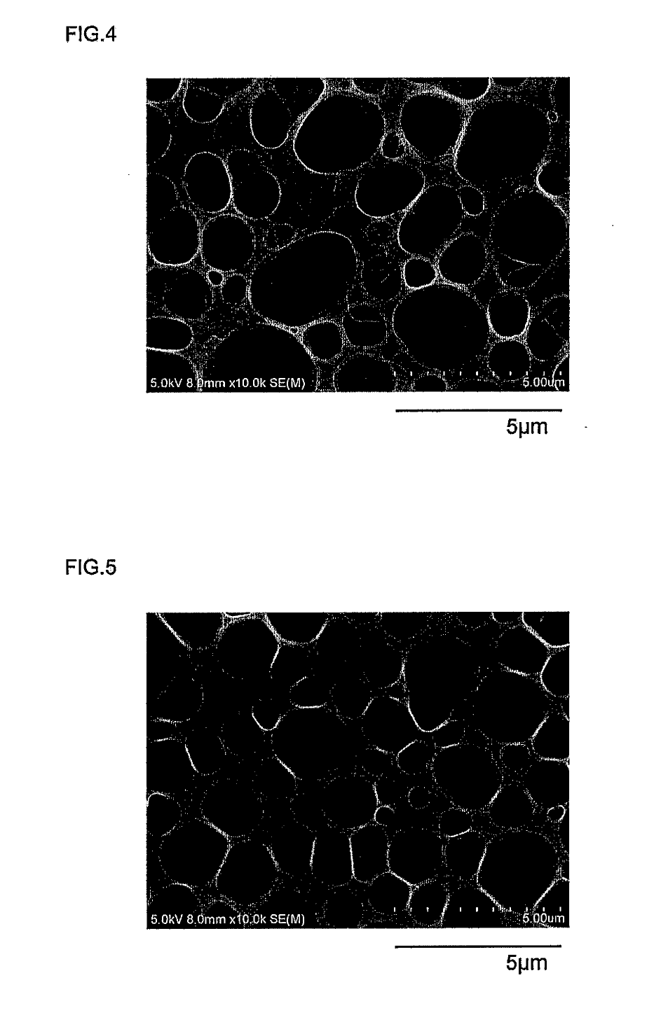

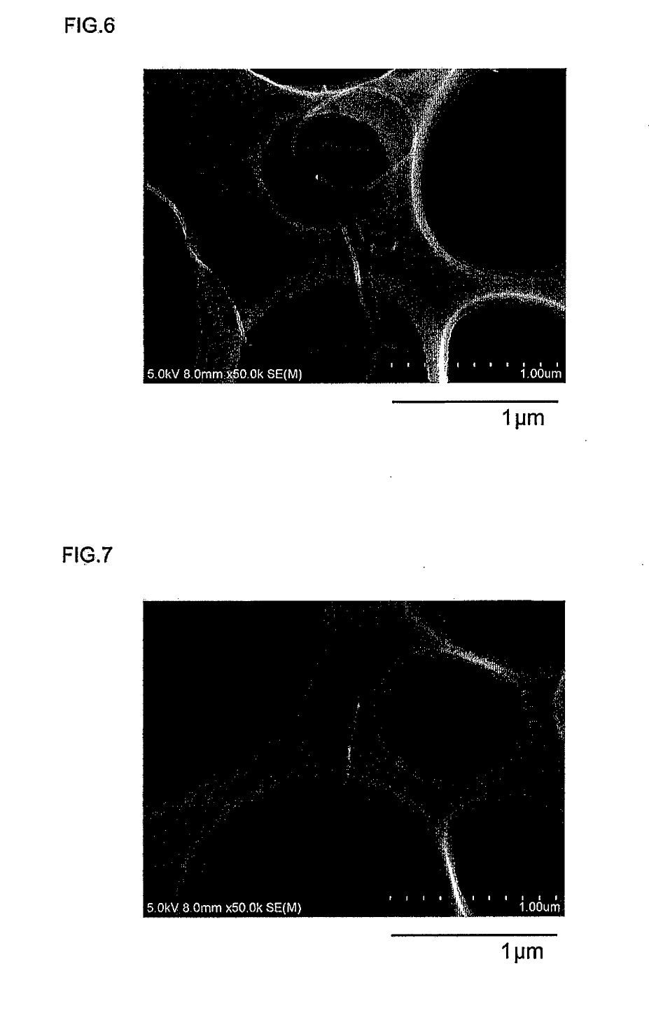

Carbon nanotube dispersions were then prepared from samples 1 and 2 using the manufacturing device 100. The carbon nanotubes in the carbon nanotube dispersions after production were then submitted to electron microscopic observation. The SEM photographs after the dispersion of sample 1 are given in FIGS. 4 and 6, and the SEM photographs after the dispersion of sample 2 are given in FIGS. 5 and 7. FIGS. 4 and 5 are SEM photographs at a 10,000× enlargement, and FIGS. 6 and 7 are SEM photographs at a 50,000× enlargement

As shown in FIGS. 2 and 3, for both samples the carbon nanotubes were long prior to the dispersion treatment and aggregates were formed in which the carbon nanotubes were aggregated with each other. On the other hand, as shown in FIGS. 4 through 7, after the dispersion treatment the carbon nanotubes were homogeneously dispersed in the liquid medium and many of the carbon nanotubes were relatively short (in this example, the length of at least 80% of the carbon nanotubes was equal to or less than 5 μm). In addition, the average value of the aspect ratio of the carbon nanotubes in sample 1 was approximately 50, while the average value of the aspect ratio of the carbon nanotubes in sample 2 was approximately 150. Thus, a carbon nanotube dispersion in which relatively short carbon nanotubes were homogeneously dispersed throughout the entire liquid medium could be produced by repeating the “carbon nanotube loading” and the “dispersion treatment” using the manufacturing device 100 equipped with a dispersing section 30 composed of an annular gap-type bead mill.

### INDUSTRIAL APPLICABILITY

The herein disclosed method for manufacturing a carbon nanotube dispersion can produce a carbon nanotube dispersion (that is, a composition in which carbon nanotubes are a major component) that exhibits a good dispersity and that contains the carbon nanotubes at a high concentration.

The carbon nanotube dispersion (composition) obtained using this manufacturing method can be favorably used, for example, as the electroconductive material that is added to the electrode mixture layer of a lithium ion secondary battery. It can also be advantageously used as a carbon nanotube material in a variety of fields.

1. A method for manufacturing a carbon nanotube dispersion in which carbon nanotubes are dispersed in a liquid medium,
the manufacturing method comprising:
loading the liquid medium into a dispersing container;
loading carbon nanotubes into the dispersing container and adjusting the viscosity of the contents of the dispersing container to between 100 cP and 100,000 cP; and
subjecting the contents of the dispersing container to a dispersion treatment using an annular gap-type bead mill until the viscosity of the contents reaches a dispersion target value set between 10 cP and 50,000 cP, wherein
the carbon nanotube loading and the dispersion treatment are repeated until the carbon nanotube concentration of the contents of the dispersing container reaches a desired value.

2. The manufacturing method according to claim 1, wherein multi-walled carbon nanotubes are used as the carbon nanotubes.

3. The manufacturing method according to claim 1, wherein a polymer compound that functions as a dispersing agent is added to the liquid medium prior to the loading of the carbon nanotubes into the dispersing container or at the same time as this loading.

4. The manufacturing method according to claim 1, wherein the average value of the aspect ratio of the carbon nanotubes after the dispersion treatment is maintained at at least 50% of the average value of the aspect ratio of the carbon nanotubes prior to loading into the dispersing container.

5. The manufacturing method according to claim 1, wherein carbon nanotubes with an average value for the aspect ratio of at least 100 are loaded into the dispersing container.

6. The manufacturing method according to claim 1, wherein the carbon nanotube loading and the dispersion treatment are repeated until the carbon nanotube concentration of the contents of the dispersing container reaches 1 mass % to 50 mass %.

7. A carbon nanotube dispersion manufactured by the manufacturing method according to claim 1.

8. A carbon nanotube dispersion in which carbon nanotubes are dispersed in a liquid medium, wherein
the concentration of the carbon nanotubes with reference to the carbon nanotube dispersion as a whole is from at least 1 mass % to not more than 50 mass %,
the viscosity of the carbon nanotube dispersion is not more than 8,000 cP, and
the average value of the aspect ratio of the carbon nanotubes is 50 to 200.

9. The carbon nanotube dispersion according to claim 8, wherein the carbon nanotubes are multi-walled carbon nanotubes.
